(19) United States
(12) Patent Application Publication
(10) Pub. No.: US 2013/0168251 A1
(43) Pub. Date: Jul. 4, 2013

(54) FILTER FOR CAPTURING POLLUTING EMISSIONS

(71) Applicant: CENTRO DE INVESTIGACION DE ROTACION Y, Madrid (ES)

(72) Inventors: Manuel DORADO GONZÁLEZ, Madrid (ES); Jaime ANDREU SERRA, Pozuelo de Alarcon (ES); Carlos MONTERO CATALINA, Alcorcon (ES)

(73) Assignee: CENTRO DE INVESTIGACION DE ROTACION Y TORQUE APLICADA, S.L., Madrid (ES)

(21) Appl. No.: 13/654,056

(22) Filed: Oct. 17, 2012

Related U.S. Application Data
(63) Continuation of application No. 11/995,305, filed on Jul. 16, 2008, now abandoned.

(30) Foreign Application Priority Data
Jul. 12, 2005 (ES) P200501693

(51) Int. Cl. B01D 35/06

(52) U.S. Cl. CPC B01D 35/06
USPC 204/664; 204/665

(57) ABSTRACT

The invention relates to a fluid filter system which can be used to separate the different substances forming said fluid. The invention is characterized in that it comprises the application of a uniform magnetic or electric field in order to produce a Stark effect and the subsequent application of an electric field oscillating in resonance with the energy separation caused by the Stark effect or by a magnetic field oscillating in resonance with the energy separation caused by the Zeeman effect. The molecules involved in the resonation are captured in the filter and subsequently removed using a suction system.

This application is a Continuation of U.S. Ser. No. 11/995,305 filed 16 Jul. 2008, which is a National Stage Application of PCT/ES2005/000701, filed 22 Dec. 2005, which claims benefit of Serial No. P200501693, filed 12 Jul. 2005 in Spain and which applications are incorporated herein by reference. To the extent appropriate, a claim of priority is made to each of the above disclosed applications.

### OBJECT OF THE INVENTION

The present invention relates to a new system for filtering pollutants in a fluid, especially designed for its use in fume purification and/or water treatment installations.

The present invention is comprised within the field of fluid purification and the substance separation methods.

### BACKGROUND OF THE ART

There are many methods and systems on the market for separating contaminants in a fluid but none like the one described in this specification.

These methods can be physical, such as fractional distillation, filtration, decantation, centrifugation, chromatography, electrolysis, etc, or chemical. Most chemical methods are based on the addition of new substances to the initial mixture; chemical bonds are thus created which modify the physical properties of said substances, and they can subsequently be separated by applying physical methods. All these methods are widely documented and are routinely used in the industry.

There are inventions for the particular case in which the metal particles present in a fluid are to be separated. In this case, a magnet is submersed in the fluid and these particles are collected (WO 2005/014486, WO 03/078069, WO 2002/094351, WO 02/094446, WO 02/094351, WO 02/081092, WO 02/20125, WO 01/78863, WO 98/16320, WO 97/04873, U.S. Pat. No. 6,846,411, U.S. Pat. No. 6,835,308, U.S. Pat. No. 6,833,069, U.S. Pat. No. 6,706,178, U.S. Pat. No. 6,649,054, U.S. Pat. No. 6,638,425, U.S. Pat. No. 6,461,504, U.S. Pat. No. 6,277,276, U.S. Pat. No. 6,210,572, U.S. Pat. No. 5,817,233, U.S. Pat. No. 4,488,962, U.S. Pat. No. 5,647,993, U.S. Pat. No. 5,468,381, U.S. Pat. No. 5,439,586, U.S. Pat. No. 5,242,587, U.S. Pat. No. 5,012,365, U.S. Pat. No. 5,009,779, U.S. Pat. No. 4,894,153, U.S. Pat. No. 4,722,788, U.S. Pat. No. 4,594,215, U.S. Pat. No. 4,468,321, U.S. Pat. No. 4,446,019, U.S. Pat. No. 4,394,264, U.S. Pat. No. 4,377,830, U.S. Pat. No. 4,363,729, U.S. Pat. No. 4,251,372, US T997,002, U.S. Pat. No. 4,209,403, U.S. Pat. No. 4,206,000, U.S. Pat. No. 4,154,682, U.S. Pat. No. 4,082,656, U.S. Pat. No. 4,054,931, U.S. Pat. No. 4,031,011, U.S. Pat. No. 4,026,805, U.S. Pat. No. 3,979,288, ESP 2,085,824, ESP 2,015825, ESP 8,700,069, ESP 8,206,202, ESP 0,467,616, ESP 0,332,684, ESP 0,246,811, ESP 0,123,480).

Systems similar to the previous one applied to the treatment of lubricants are also described (WO 97/26977, WO 97/09275, U.S. Pat. No. 6,729,442, U.S. Pat. No. 6,554,999, U.S. Pat. No. 6,524,476, U.S. Pat. No. 6,503,393, U.S. Pat. No. 6,413,421, U.S. Pat. No. 6,337,012, U.S. Pat. No. 6,207,050, U.S. Pat. No. 6,162,357, U.S. Pat. No. 6,139,737, U.S. Pat. No. 5,932,108, U.S. Pat. No. 5,702,598, U.S. Pat. No. 5,423,983, U.S. Pat. No. 5,078,871, U.S. Pat. No. 4,826,592, 4,763,092, U.S. Pat. No. 5,389,252, U.S. Pat. No. 5,354,462, U.S. Pat. No. 4,705,626, U.S. Pat. No. 4,613,435, U.S. Pat. No. 4,450,075, U.S. Pat. No. 4,293,410, U.S. Pat. No. 4,176,065, U.S. Pat. No. 6,551,506, U.S. Pat. No. 6,444,123, U.S. Pat. No. 5,571,411, ESP 0,274,276, ESP 0,314,351.)

Some methods apply these magnetic separation systems when metal particles in a gaseous fluid are to be separated (U.S. Pat. No. 6,897,718, U.S. Pat. No. 6,750,723, U.S. Pat. No. 6,594,157). In other cases, a metal substance is reacted with other substances to provide them with magnetic properties and thus enable them to be separated by means of using these magnetic filters (U.S. Pat. No. 5,122,269).

Magnetic filters can also be used to separate ionized particles, electrons or any other type of particle with an electric charge (U.S. Pat. No. 6,559,445, U.S. Pat. No. 6,441,378, U.S. Pat. No. 6,094,012, U.S. Pat. No. 6,016,036).

Another type of filter uses the interaction of non-uniform electric and magnetic fields, where there is a strong field gradient, with the magnetic and/or electric dipole moments of neutral particles. These particles are deflected by this process from their original path (U.S. Pat. No. 6,251,282).

No filtration system and/or method based on the application of external (electric and/or magnetic) force fields in resonance with energy transitions of the substances to be captured has been described to date.

### DESCRIPTION OF THE INVENTION

The present invention relates to a system which allows filtering pollutants present in a fluid by means of the application of several electric and/or magnetic fields perpendicular to one another and in resonance with energy transition of the molecules to be filtered.

The system described below can be applied by means of using electric or magnetic fields without distinction. To simplify the drafting of the text, electric fields will be referred to hereinafter although it must be understood that everything relating to these fields can also be applied to the use of magnetic fields.

The generation of a uniform electric field is first required, by means of applying a potential difference between 2 metal elements (copper sheets, or any similar element which allows generating the uniform electric field). The uniform field will hereinafter be referred to as U.F. for the sake of simplification. The fluid from which the substances to be filtered are to be extracted must traverse said U.F. and once inside it, a new field perpendicular to the previous one and oscillating (which will be referred to as O.F.) must be applied such that the oscillation frequency of O.F. is in resonance with the separation of energy levels caused by U.F. in the molecules to be filtered.

It is known that any molecule in the presence of an external field causes an effect called Stark effect (when it is in the presence of an electric field) or Zeeman effect (when it is in the presence of a magnetic field). This Zeeman or Stark effect causes the splitting of the (electronic, vibrational or rotational) energy levels of the molecules. Transitions between different energy levels can be established, i.e. the molecule changes from one energy state to another when a energy radiation equivalent to the separation of the levels between which the change occurs is applied. This process is known as resonance.

Considering that the molecules with which resonance is to occur cover a path through the filter, when the resonance phenomenon occurs in the aforementioned conditions, a deflection from the original path is caused and the molecule follows a new path which can be controlled by modifying the U.F. and O.F. intensity.

The optimal conditions for causing the molecules to be eliminated from the fluid to be retained in the application area of the effect can be calculated. Once enough molecules for reaching a high concentration have been captured, their extraction is enabled by means of using a suction system.

The application of the system can be repeated as many times as desired for the purpose of improving the yield of the filtration process.

If different compounds in one and the same fluid are to be captured, several pieces of filtration equipment arranged in series can be used, each of them in resonance with the molecule to be captured.

### PREFERRED EMBODIMENT

The present invention is illustrated by means of the following example which by no means limits its scope, which is exclusively defined by the claims.

Filtration of a Fluid by the Application of Fields in Resonance with the Molecules to be Captured

An experimental assembly such as the one describe din FIG. 1 is considered.

This assembly is not carried out to scale. The system is formed by a support (S) with the shape of a hollow cylinder, supporting a metal surface with a cylindrical shape (E2). From the support (S), a rod (made of material insulating from electric current) penetrates towards the inside of the cylinder, which rod supports two other metal cylinders called (E1) and (E3), electrically insulated from one another.

E1 and E3 are at the same potential. A potential difference generating a uniform field U.F. is applied between E2 and the area comprised by E1 and E3, the lines of force of which field start from E1 and E3, reaching E2. At the same time, a potential difference is applied between E1 and E3, such that these two elements behave as an antenna, radiating an oscillating field O.F. which is perpendicular to U.F.

Maintaining the oscillation frequency of the O.F. in resonance with the transitions generated by the U.F. in the molecules to be filtered, said molecules can be trapped in the area close to the separation between El and E3. Maintaining the system activated, the concentration of these molecules, involved in the resonation, increases in the area comprised between El and E3. Suction vales located around (S) and which have been called (V) are periodically opened. The outlet of said valves is channeled to a tank in which the captured substances are stored.

A practical example is shown in FIG. 2, in which the filter is applied to the separation of molecular hydrogen from a mixture of hydrogen and helium. It can be observed how the rotational state of the molecule involved in the resonation is accurately separated.

### BRIEF DESCRIPTION OF THE DRAWINGS

FIG. 1 shows a schematic view of the experimental system for the case in which an electric force field is used, box (A) shows the elevational or side view and box (P) shows the plan or upper view. The following abbreviations are used:
S: Hollow cylindrical support.
E2: Hollow cylinder made of material conducting electric current.
E1 and E3: Cylinders made of material conducting electric current separated from one another by a small strip of material that does not conduct electric current. V: Valves which can be pulsed connected to an external vacuum system (it is not included in the figure), such that when they are opened, they suction the substances captured inside (S).

FIG. 2 shows a spectrum in which molecular hydrogen is separated from a mixture of hydrogen and helium. The vertical axis shows the signal intensity, which is proportional to the concentration of molecular hydrogen, traversing the filter. The horizontal axis shows the frequency of the oscillating field. For a uniform field of 100 Gauss, it is observed how the hydrogen coming out of the filter decreases in 100% of the state involved in the resonation.

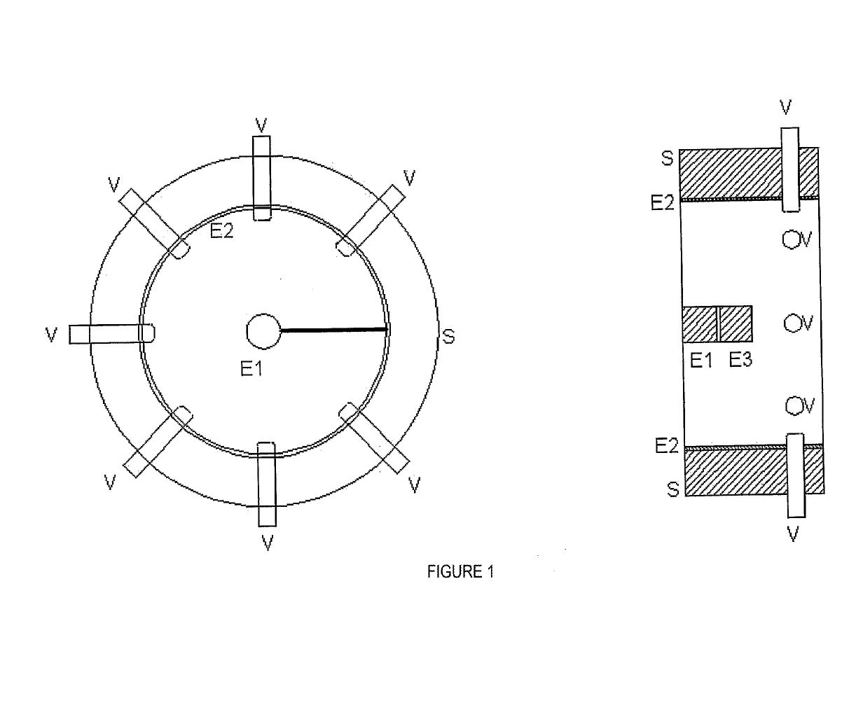

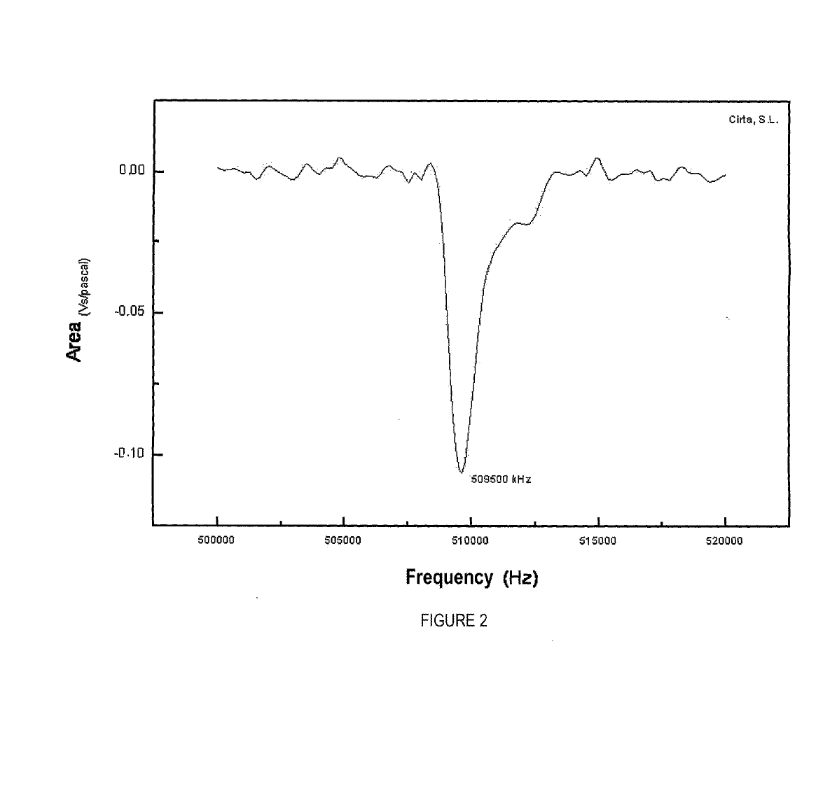

1. A fluid filter system which can be used to separate the different substances that can form said fluid, characterized by the application of a uniform electric field in order to cause a Stark effect and the simultaneous application of an electric field oscillating in resonance with the energy separation caused by the Stark effect.

2. A fluid filter system which can be used to separate the different substances that can form said fluid according to claim 1, characterized in that the oscillating electric field and the uniform electric field are perpendicular to one another.

3. A fluid filter system which can be used to separate the different substances that can form said fluid according to claims 1 and 2, characterized by the substitution of the uniform electric field with a non-uniform electric field having a gradient, such that the resonation of different substances is achieved by fixing the oscillating electric field.

4. A fluid filter system which can be used to separate the different substances that can form said fluid according to claims 1, 2 and 3, characterized by the substitution of the electric fields with magnetic fields, thus causing a resonant Zeeman effect instead of a Stark effect.

5. A fluid filter system which can be used to separate the different substances that can form said fluid according to claims 1, 2, 3 and 4, characterized in that the substances captured in the filter are removed thanks to a suction system formed by pulsed valves or any other system causing the same suction effect.

6. A fluid filter system which can be used to separate the different substances that can form said fluid according 1, 2, 3, 4 and 5, characterized by the repetition of the method n-times applied to one and the same substance or to several substances, simultaneously or sequentially.

7. A fluid filter system which can be used to separate the different substances that can form said fluid according to claims 1, 2, 3, 4, 5 and 6, characterized by its application to the individual or joint capture of carbon dioxide, carbon monoxide, dinitrogen monoxide, nitrogen monoxide, dinitrogen trioxide, dinitrogen tetroxide, nitrogen dioxide, dinitrogen pentoxide, sulfur dioxide, sulfur trioxide, hydrogen sulfide, water, deuterated water, hydrogen, deuterated hydrogen, deuterium, tritium, molecular oxygen, ammonia, butylamine, dibutylamine, diisopropylamine, dimethylamine, ethylamine, methylamine, trimetylamine, pyridine, skatole, diphenyl sulfide, dimethyl sulfide, allyl mercaptan, amyl mercaptan, benzyl mercaptan, ethyl mercaptan, methyl mercaptan, propyl mercaptan, phenyl mercaptan, butyl mercaptan, acetaldehydes, chlorodibenzodioxins, chlorodibenzofurans or any other molecule on which the resonance phenomenon described in the present invention can be applied.
